(19) United States
(12) Patent Application Publication
(10) Pub. No.: US 2016/0112277 A1
(43) Pub. Date: Apr. 21, 2016

(54) OPTICAL CHANNEL TRACING IN A LINK VIEWER

(71) Applicant: Infinera Corporation, Sunnyvale, CA (US)

(72) Inventors: Karthikeyan M. NAGARAJAN, Bangalore (IN); Yashpal Kumar, Bangalore (IN); Lam D. Hoang, San Jose, CA (US)

(21) Appl. No.: 14/514,801

(22) Filed: Oct. 15, 2014

(51) Int. Cl. H04L 12/24; G06F 3/0484; H04B 10/27

(52) U.S. Cl. CPC H04L 41/22; H04B 10/27; G06F 3/04842; G06F 3/04847

(57) ABSTRACT

A device may be configured to receive network information for an optical network. The device may provide a user interface for display based on the network information. The user interface may include first display elements representing physical components in the optical network, second display elements representing logical components in the optical network, third display elements representing physical connections in the optical network, and fourth display elements representing logical connections in the optical network. The user interface may provide information regarding optical channels transmitted via the optical network. The device may visually distinguish, within the user interface and based on a selection, a transmission path associated with an optical channel of the optical channels. The transmission path may include at least one of the physical components, at least one of the logical components, at least one of the physical connections, and at least one of the logical connections.

### BACKGROUND

In optical networks, signals may be transmitted at various wavelengths, with each wavelength corresponding to a transmission channel. Optical links may connect network nodes so that signals may be transmitted throughout the optical network. An optical route may use a series of network nodes and optical links to connect a source of an optical transmission with a destination for the optical transmission.

### SUMMARY

Some implementations described herein may provide a device configured to receive network information for an optical network. The network information may originate from at least one network device included in the optical network. The device may provide a user interface for display based on the network information. The user interface may include first display elements representing physical components in the optical network, second display elements representing logical components in the optical network, third display elements representing physical connections in the optical network, and fourth display elements representing logical connections in the optical network. The user interface may provide information regarding a plurality of optical channels transmitted via one or more of the physical components, one or more of the logical components, one or more of the physical connections, and one or more of the logical connections. The device may receive a selection of an optical channel of the plurality of optical channels via the user interface. The device may visually distinguish, within the user interface and based on the selection, a transmission path associated with the optical channel. The transmission path may include at least one of the physical components, at least one of the logical components, at least one of the physical connections, and at least one of the logical connections.

Some implementations described herein may provide a computer-readable medium storing instructions. The instructions, when executed by one or more processors, may cause the one or more processors to receive network information for an optical network. The network information may originate from at least one network device included in the optical network. The instructions may cause the processors to provide a user interface for display based on the network information. The user interface may include first display elements representing physical components in the optical network, second display elements representing logical components in the optical network, third display elements representing physical connections in the optical network, fourth display elements representing logical connections in the optical network, fifth display elements indicating optical channels transmitted via one or more of the physical components, one or more of the logical components, one or more of the physical connections, and one or more of the logical connections. The instructions may cause the processors to receive a selection of a subset of the optical channels via the user interface. The instructions may cause the processors to filter the user interface based on the selection to form a filtered user interface. The filtered user interface may include a subset of the fifth display elements that are associated with the subset of the optical channels. The instructions may cause the processors to provide the filtered user interface for display.

Some implementations described herein may provide a method including receiving, by a device, network information for an optical network. The network information may originate from at least one network device included in the optical network. The method may include providing, by the device, a user interface for display based on the network information. The user interface may include first display elements representing physical components in the optical network, second display elements representing logical components in the optical network, third display elements representing physical connections in the optical network, fourth display elements representing logical connections in the optical network, and fifth display elements representing a plurality of super-channels transmitted via one or more of the physical components, one or more of the logical components, one or more of the physical connections, and/or one or more of the logical connections. The method may include receiving, by the device, a selection of a super-channel of the plurality of super-channels via the user interface. The method may include causing, by the device, the user interface to visually distinguish, based on the selection, a transmission path associated with the super-channel. The transmission path may include at least one of the physical components, at least one of the logical components, at least one of the physical connections, and/or at least one of the logical connections.

### BRIEF DESCRIPTION OF THE DRAWINGS

FIGS. 1A and 1B are diagrams of an overview of an implementation described herein;

FIG. 2A is a diagram of an example environment in which systems and/or methods described herein may be implemented;

FIG. 2B is a diagram of example devices of an optical network that may be monitored according to implementations described herein;

FIG. 2C is a diagram of example super-channels that may be monitored and/or configured according to implementations described herein;

FIG. 3 is a diagram of example components of one or more devices and/or systems of FIG. 2A and/or FIG. 2B;

FIG. 4 is a diagram of example functional components of one or more devices of FIG. 2A and/or FIG. 2B;

FIG. 5 is a diagram of an example process for receiving and storing network information;

FIGS. 6A and 6B are diagrams of an example process for providing a user interface with information for an optical channel;

FIG. 7 is a diagram of an example implementation relating to the example process shown in FIGS. 6A and 6B;

FIGS. 8A and 8B are diagrams of an example implementation relating to the example process shown in FIGS. 6A and 6B;

FIG. 9 is a diagram of an example implementation relating to the example process shown in FIGS. 6A and 6B;

FIGS. 10A and 10B are diagrams of an example implementation relating to the example process shown in FIGS. 6A and 6B; and

FIG. 11 is a diagram of an example implementation relating to the example process shown in FIGS. 6A and 6B.

### DETAILED DESCRIPTION

The following detailed description of example implementations refers to the accompanying drawings. The same reference numbers in different drawings may identify the same or similar elements.

A user of an optical network may want to determine information associated with the optical network. However, network information may be difficult to obtain, aggregate, and display. For example, information about one or more optical channels (e.g., optical super-channels) may be difficult to display to a user in a way that the user may easily comprehend a route of the optical channel between network elements.

Implementations described herein may assist a user in obtaining and viewing aggregated network information, such as network information associated with network devices and optical channels transferred between the network devices. For example, implementations described herein may allow a user to trace optical channels via a user interface (UI), filter the optical channels displayed in the UI, and/or switch between different optical channels displayed in the UI. Accordingly, the user may easily comprehend the path through which an optical channel travels even if switching of optical channels is possible (e.g., when super-channels pass through a reconfigurable optical add-drop multiplexer (ROADM)).

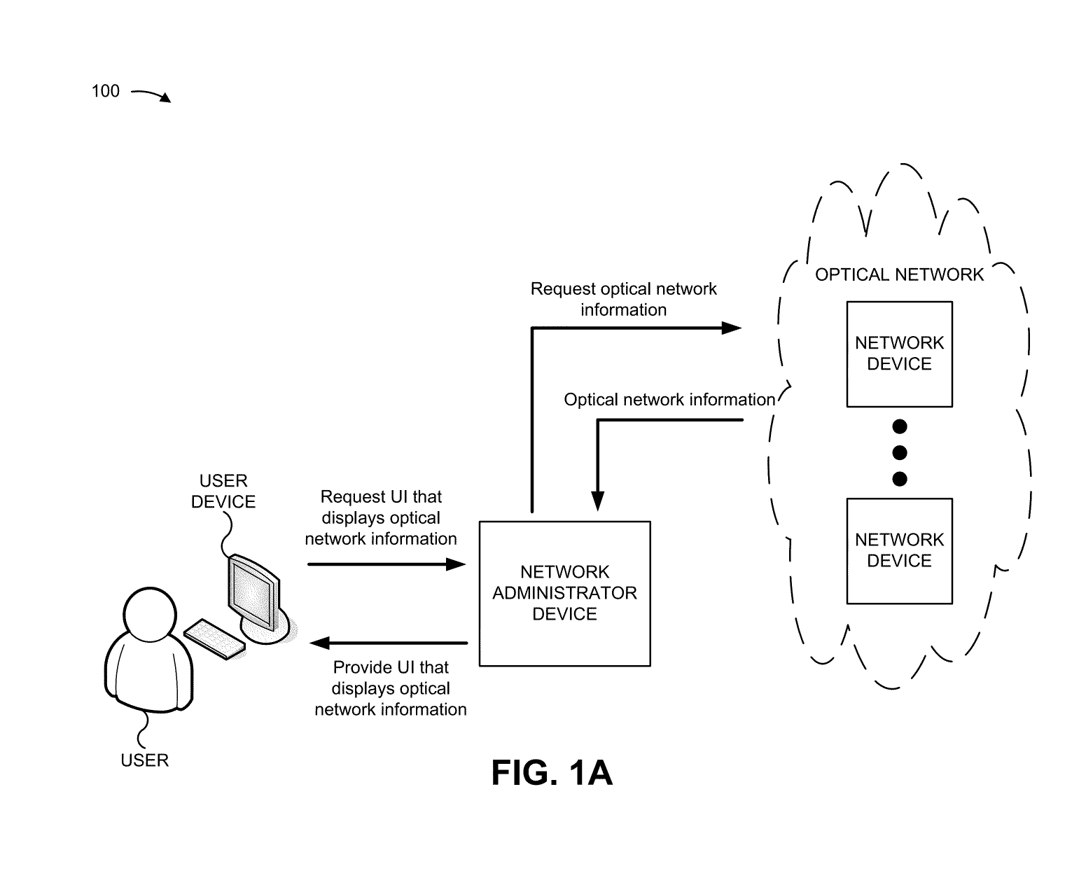

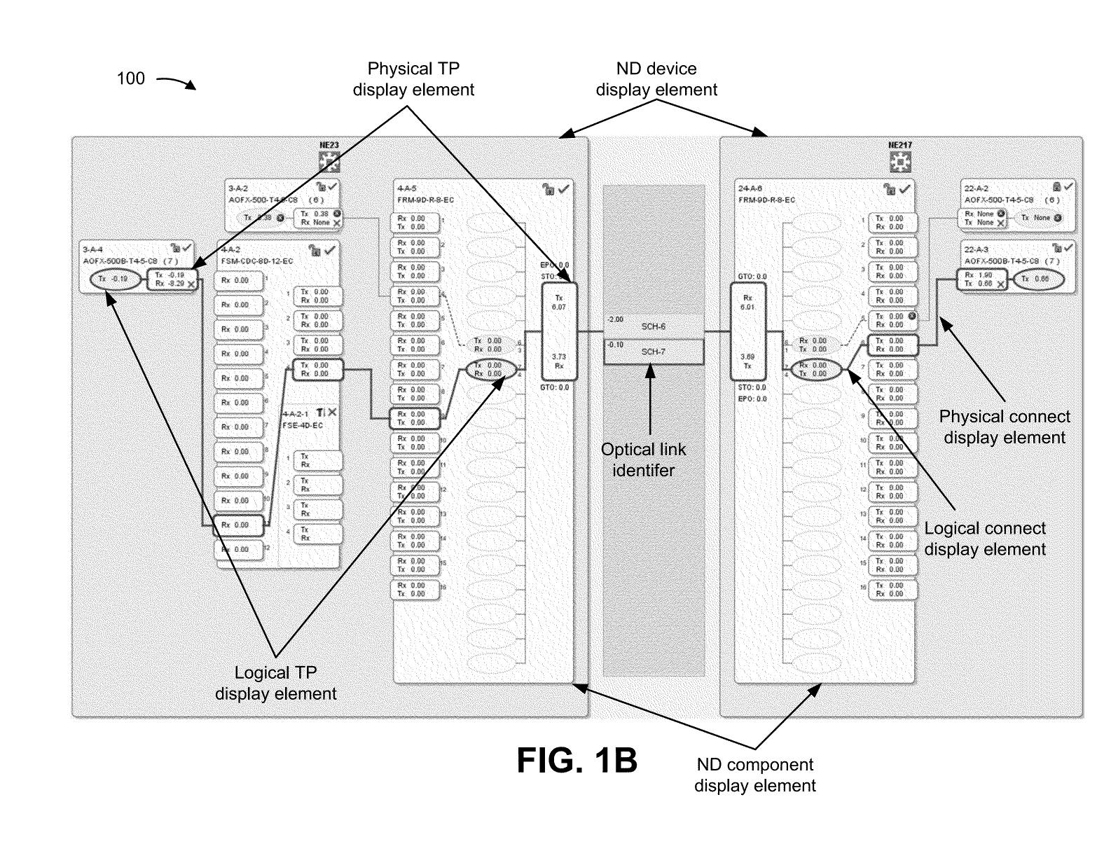

FIGS. 1A and 1B are diagrams of an overview of an example implementation 100 described herein. As illustrated in FIG. 1A, a user interacting with a user device may request, from a network administrator device, a UI that displays network information. The network administrator device may request the network information from one or more network devices in an optical network. The network administrator device may receive the requested information from the network devices, and may provide the requested UI to the user device.

FIG. 1B shows an example of the UI provided to the user device. The UI may be in an optical channel view mode that displays a representation of an optical channel through network devices in the optical network. For example, the UI may include network device (ND) display elements, ND component display elements, physical transmission path (TP) display elements, logical TP display elements, physical connect display elements, logical connect display elements, and/or optical channel identifiers.

A ND display element may represent a network device in the optical network. The ND display element may include one or more ND component display elements that represent components within a network device. A TP display element may represent a physical component (e.g., a port) used to transmit or receive an optical channel within a component of the network device. A logical TP display element may represent a logical component within a component of the network device. A physical connect display element may represent a physical connection (e.g., an optical link) between two components. A logical connect display element may represent a logical connection between two components. The optical channel identifier may identify an optical channel (e.g., a super-channel) and/or an optical channel placement in spectrum.

As shown in FIG. 1B, an optical channel may be traced within the UI to show a transmission path by the optical channel. For example, as shown in FIG. 1B, the optical channel for super-channel 7 (SCH-7) is highlighted to make the transmission path easily discernible to the user. For instance, each physical TP display element, logical TP display element, physical connect display element, and logical connect display element that represents a component through which super-channel 7 travels may be highlighted. The optical channel identifier for super-channel 7 may also be highlighted.

In this way, a user interface may trace an optical channel (e.g., super-channel 7) in a link viewer (e.g., a UI) so that a user may easily comprehend the path through which the optical channel travels.

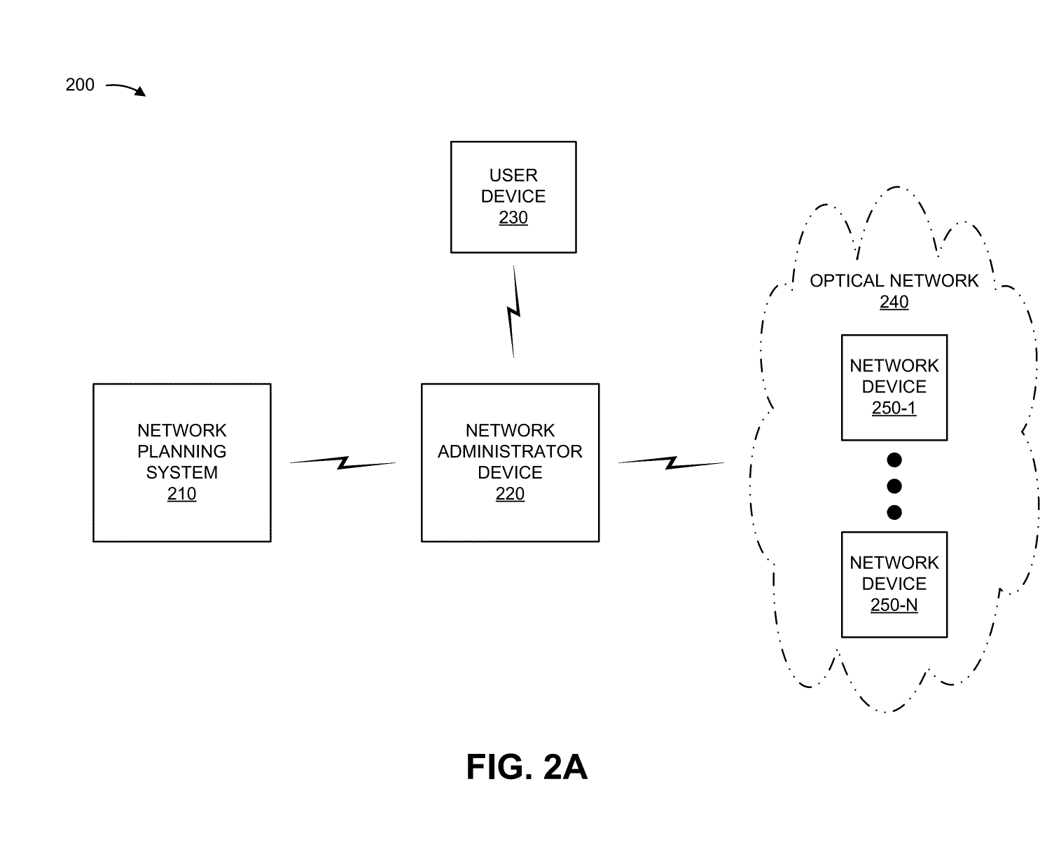

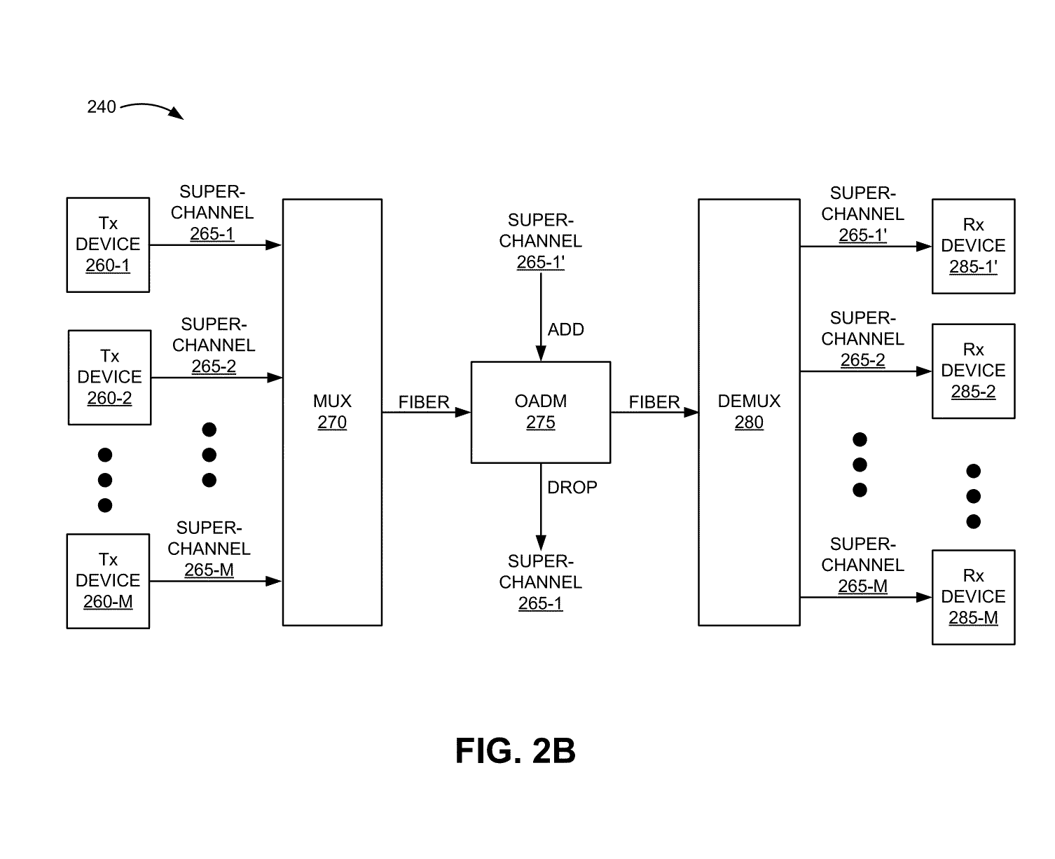

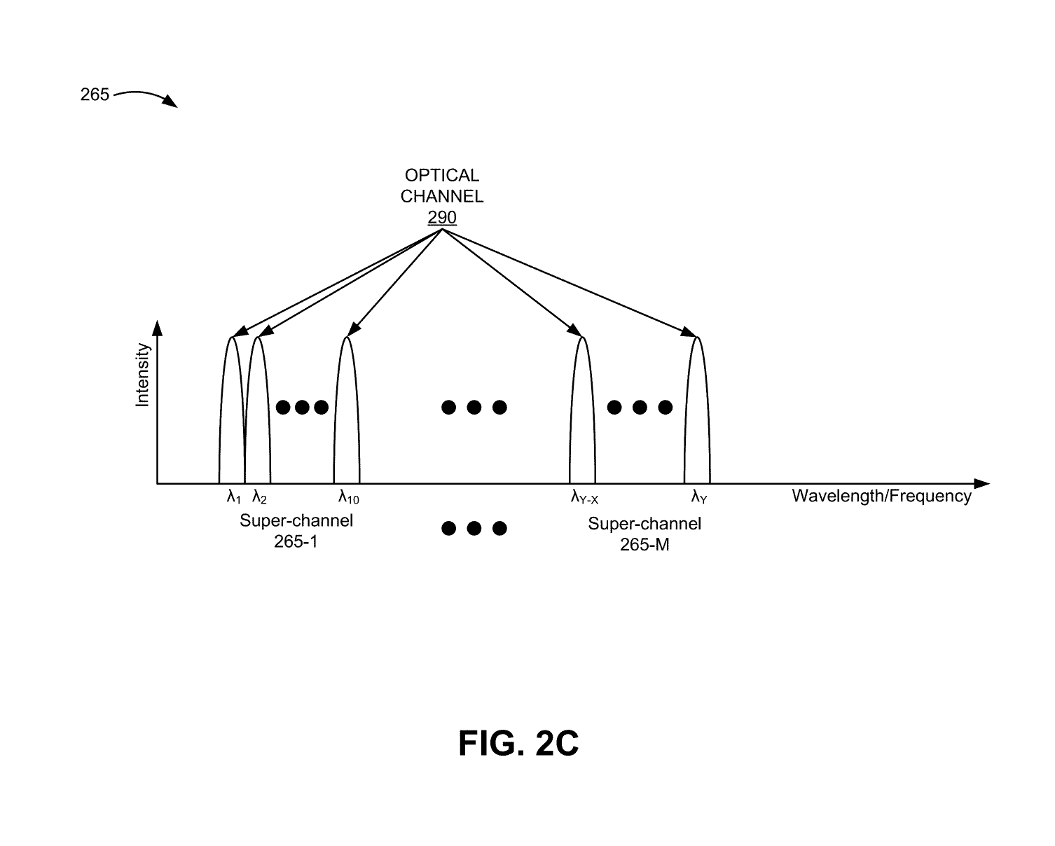

FIG. 2A is a diagram of an example environment 200 in which systems and/or methods described herein may be implemented. Environment 200 may include a network planning system 210 (“NPS 210”), a network administrator device 220 (“NA 220”), a user device 230, and an optical network 240 that includes one or more network devices 250-1 through 250-N (N≧1) (hereinafter referred to individually as “ND 250” and collectively as “NDs 250”).

NPS 210 may include one or more devices that gather, process, search, store, and/or provide information in a manner described herein. NPS 210 may assist a user in modeling and/or planning an optical network, such as optical network 240. For example, NPS 210 may assist in modeling and/or planning an optical network configuration, which may include quantities, locations, capacities, parameters, and/or configurations of NDs 250, characteristics and/or configurations (e.g., capacities) of optical links between NDs 250, traffic demands of NDs 250 and/or optical links between NDs 250, and/or any other network information associated with optical network 240 (e.g., optical device configurations, digital device configurations, etc.). NPS 210 may provide information associated with optical network 240 to NA 220 so that a user may view, change, and/or interact with the network information.

As used herein, an optical channel may be an optical super-channel, a super-channel group, an optical channel group, a set of spectral slices, an optical control channel (e.g., sometimes referred to herein as an optical supervisory channel, or an “OSC”), an optical data channel (e.g., sometimes referred to herein as “BAND”), and/or any other optical channel. As used herein, an optical link may be an optical fiber and/or other physical connection between network devices and/or between components of a network device.

In some implementations, an optical channel may be an optical super-channel. A super-channel may include multiple channels multiplexed together using wavelength-division multiplexing in order to increase transmission capacity. Various quantities of channels may be combined into super-channels using various modulation formats to create different super-channel types having different characteristics. Additionally, or alternatively, an optical channel may be a super-channel group. A super-channel group may include multiple super-channels multiplexed together using wavelength-division multiplexing in order to increase transmission capacity.

Additionally, or alternatively, an optical channel may be a set of spectral slices. A spectral slice (a “slice”) may represent a spectrum of a particular size in a frequency band (e.g., 12.5 gigahertz (“GHz”), 6.25 GHz, etc.). For example, a 4.8 terahertz (“THz”) frequency band may include 384 spectral slices, where each spectral slice may represent 12.5 GHz of the 4.8 THz spectrum. A super-channel may include a different quantity of spectral slices depending on the super-channel type.

NA 220 may include one or more devices that gather, process, search, store, and/or provide information in a manner described herein. NA 220 may receive the network information, and may provide the network information for display via a UI. For example, NA 220 may receive the network information from NPS 210, user device 230, optical network 240, and/or NDs 250. NA 220 may provide the network information to another device, such as user device 230, so that a user may interact with the network information. NA 220 may receive information associated with changes to optical network 240 from another device (e.g., user device 230). NA 220 may provide information associated with the network changes to optical network 240 and/or NDs 250 in order to configure optical network 240 based on the information associated with network changes. NA 220 may provide information associated with network changes to another device, such as user device 230, so that a user may interact with the changed network information.

User device 230 may include one or more devices that gather, process, search, store, and/or provide information in a manner described herein. For example, user device 230 may include a communications and/or computing device, such as a mobile phone (e.g., a smart phone, a radiotelephone, etc.), a laptop computer, a tablet computer, a handheld computer, a desktop computer, or a similar device. User device 230 may provide information to and/or receive information from other devices, such as NA 220. For example, user device 230 may receive network information from NA 220, and may send information associated with network changes to NA 220.

Optical network 240 may include any type of network that uses light as a transmission medium. For example, optical network 240 may include a fiber-optic based network, an optical transport network, a light-emitting diode network, a laser diode network, an infrared network, and/or a combination of these or other types of optical networks.

ND 250 may include one or more devices that gather, process, store, and/or provide information in a manner described herein. For example, ND 250 may include one or more optical data processing and/or traffic transfer devices, such as an optical node, an optical amplifier (e.g., a doped fiber amplifier, an erbium doped fiber amplifier, a Raman amplifier, etc.), an optical add-drop multiplexer (“OADM”), a ROADM, a flexibly reconfigurable optical add-drop multiplexer module (“FRM”), an optical source component (e.g., a laser source), an optical source destination (e.g., a laser sink), an optical multiplexer, an optical demultiplexer, an optical transmitter, an optical receiver, an optical transceiver, a photonic integrated circuit, an integrated optical circuit, and/or any other type of device capable of processing and/or transferring optical traffic.

In some implementations, ND 250 may include an OADM and/or a ROADM capable of being configured to add, drop, multiplex, and demultiplex optical signals. ND 250 may process and transmit optical signals to other NDs 250 throughout optical network 240 in order to deliver optical transmissions.

The number and arrangement of devices and/or networks illustrated in FIG. 2A are provided for explanatory purposes. In practice, there may be additional devices and/or networks, fewer devices and/or networks, different devices and/or networks, or differently arranged devices and/or networks than are shown in FIG. 2A. Furthermore, two or more of the devices illustrated in FIG. 2A may be implemented within a single device, or a single device illustrated in FIG. 2A may be implemented as multiple, distributed devices. Additionally, or alternatively, one or more of the devices of environment 200 may perform one or more functions described as being performed by another one or more of the devices of environment 200. Devices of environment 200 may interconnect via wired connections, wireless connections, or a combination of wired and wireless connections.

FIG. 2B is a diagram of example devices of optical network 240 that may be monitored according to implementations described herein. One or more devices illustrated in FIG. 2B may operate within optical network 240, and may correspond to NDs 250. Optical network 240 may include one or more optical transmitter devices 260-1 through 260-M (M≧1) (hereinafter referred to individually as “Tx device 260” and collectively as “Tx devices 260”), one or more super-channels 265-1 through 265-M (M≧1) (hereinafter referred to individually as “super-channel 265” and collectively as “super-channels 265”), a multiplexer (“MUX”) 270, an OADM 275, a demultiplexer (“DEMUX”) 280, and one or more optical receiver devices 285-1 through 285-M (M≧1) (hereinafter referred to individually as “Rx device 285” and collectively as “Rx devices 285”).

Tx device 260 may correspond to ND 250. For example, Tx device 260 may include an optical transmitter and/or an optical transceiver that generates an optical signal. Tx device 260 may include one or more lasers, modulators, digital signal processors, multiplexers, and/or the like. In some implementations, Tx device 260 may be implemented on one or more integrated circuits, such as one or more photonic integrated circuits (PICs), one or more application specific integrated circuits (ASICs), or the like. One or more optical signals may be carried via super-channel 265. Additionally, or alternatively, Tx device 260 may be associated with one super-channel 265. In some implementations, Tx device 260 may be associated with multiple super-channels 265. Additionally, or alternatively, multiple Tx devices 260 may be associated with one super-channel 265. Examples of super-channels 265 will be described with respect to FIG. 2C.

MUX 270 may correspond to ND 250. For example, MUX 270 may include an optical multiplexer that combines multiple input super-channels 265 for transmission over an output fiber.

OADM 275 may correspond to ND 250. For example, OADM 275 may include a remotely reconfigurable optical add-drop multiplexer. OADM 275 may multiplex, de-multiplex, add, drop, and/or route multiple super-channels 265 into and/or out of a fiber (e.g., a single mode fiber). As illustrated, OADM 275 may drop super-channel 265-1 from a fiber, and may allow super-channels 265-2 through 265-M to continue propagating toward Rx device 285. Dropped super-channel 265-1 may be provided to a device (not shown) that may demodulate and/or otherwise process super-channel 265-1 to output the data stream carried by super-channel 265-1. As illustrated, super-channel 265-1 may be provisioned for transmission from Tx device 260-1 to OADM 275, where super-channel 265-1 may be dropped.

As further illustrated in FIG. 2B, OADM 275 may add super-channel 265-1′ (e.g., 265-1^{prime}) to the fiber. Super-channel 265-1′ may include optical channels 290 at the same or substantially the same wavelengths as super-channel 265-1. Super-channel 265-1′ and super-channels 265-2 through 265-M may propagate to DEMUX 280.

DEMUX 280 may correspond to ND 250. For example, DEMUX 280 may include an optical de-multiplexer that separates multiple super-channels 265 carried over an input fiber. For example, DEMUX 280 may separate super-channels 265-1′ and super-channels 265-2 through 265-M, and may provide each super-channel 265 to a corresponding Rx device 285.

Rx device 285 may correspond to ND 250. For example, Rx device 285 may include an optical receiver and/or an optical transceiver that receives an optical signal. One or more optical signals may be received at Rx device 285 via super-channel 265. Rx device 285 may include one or more lasers, modulators, digital signal processors, multiplexers, and/or the like. In some implementations, Rx device 285 may be implemented on one or more integrated circuits, such as one or more PICs, one or more ASICs, or the like. Rx device 285 may convert a super-channel 265 into one or more optical channels, which may be converted into one or more electrical signals, which may be processed to output the information associated with each data stream carried by optical channels 290 included in super-channel 265. In some implementations, Rx device 285 may be associated with one super-channel 265. In some implementations, Rx device 285 may be associated with multiple super-channels 265. In some implementations, multiple Rx devices 285 may be associated with one super-channel 265.

The number and arrangement of devices illustrated in FIG. 2B are provided for explanatory purposes. In practice, there may be additional devices, fewer devices, different devices, or differently arranged devices than are shown in FIG. 2B. Furthermore, two or more of the devices illustrated in FIG. 2B may be implemented within a single device, or a single device illustrated in FIG. 2B may be implemented as multiple, distributed devices. Additionally, one or more of the devices illustrated in FIG. 2B may perform one or more functions described as being performed by another one or more of the devices illustrated in FIG. 2B. Devices illustrated in FIG. 2B may interconnect via wired connections (e.g., fiber-optic connections).

FIG. 2C is a diagram of example super-channels 265 that may be monitored and/or configured according to implementations described herein. A super-channel, as used herein, may refer to multiple optical channels that are simultaneously transported over the same optical waveguide (e.g., a single mode optical fiber). Each optical channel included in a super-channel may be associated with a particular optical wavelength (or set of optical wavelengths). The multiple optical channels may be combined to create a super-channel using wavelength division multiplexing. For example, the multiple optical channels may be combined using dense wavelength division multiplexing, in which channel-to-channel spacing may be less than 1 nanometer. In some implementations, each optical channel may be modulated to carry an optical signal.

An example frequency and/or wavelength spectrum associated with super-channels 265 is illustrated in FIG. 2C. In some implementations, the frequency and/or wavelength spectrum may be associated with a particular optical spectrum (e.g., C Band, C+Band, CDC Band, etc.). As illustrated, super-channel 265-1 may include multiple optical channels 290, each of which corresponds to a wavelength λ (e.g., λ₁, λ₂, through λ₁₀) within a first wavelength band. Similarly, super-channel 265-M may include multiple optical channels 290, each of which corresponds to a wavelength λ (e.g., λ_{Y-X} through λ_{Y}) within a second wavelength band. The quantity of illustrated optical channels 290 per super-channel 265 is provided for explanatory purposes. In practice, super-channel 265 may include any quantity of optical channels 290.

Optical channel 290 may be associated with a particular frequency and/or wavelength of light. In some implementations, optical channel 290 may be associated with a frequency and/or wavelength at which the intensity of light carried by optical channel 290 is strongest (e.g., a peak intensity, illustrated by the peaks on each optical channel 290). In some implementations, optical channel 290 may be associated with a set of frequencies and/or a set of wavelengths centered at a central frequency and/or wavelength. The intensity of light at the frequencies and/or wavelengths around the central frequency and/or wavelength may be weaker than the intensity of light at the central frequency and/or wavelength, as illustrated.

In some implementations, the spacing between adjacent wavelengths (e.g., λ₁ and λ₂) may be equal to or substantially equal to a bandwidth (or bit rate) associated with a data stream carried by optical channel 290. For example, assume each optical channel 290 included in super-channel 265-1 (e.g., λ₁ through λ₁₀) is associated with a 50 Gigabit per second (“Gbps”) data stream. In this example, super-channel 265-1 may have a collective data rate of 500 Gbps (e.g., 50 Gbps×10). In some implementations, the collective data rate of super-channel 265 may be greater than or equal to 100 Gbps. Additionally, or alternatively, the spacing between adjacent wavelengths may be non-uniform, and may vary within a particular super-channel band (e.g., super-channel 265-1). In some implementations, optical channels 290 included in super-channel 265 may be non-adjacent (e.g., may be associated with non-adjacent wavelengths in an optical spectrum).

Each super-channel 265 may be provisioned in optical network 240 as one optical channel and/or as an individual optical channel. Provisioning of an optical channel may include designating a route for the optical channel through optical network 240. For example, an optical channel may be provisioned to be transmitted via a set of NDs 250. In some implementations, NDs 250 may be configured as a ring. Additionally, or alternatively, NDs 250 may be configured in a point-to-point configuration. Provisioning may be referred to as “allocating” and/or “allocation” herein. Even though each super-channel 265 is a composite of multiple optical channels 290, the optical channels 290 included in super-channel 265 may be routed together through optical network 240. Additionally, or alternatively, super-channel 265 may be managed and/or controlled in optical network 240 as though super-channel 265 included one optical channel at one wavelength.

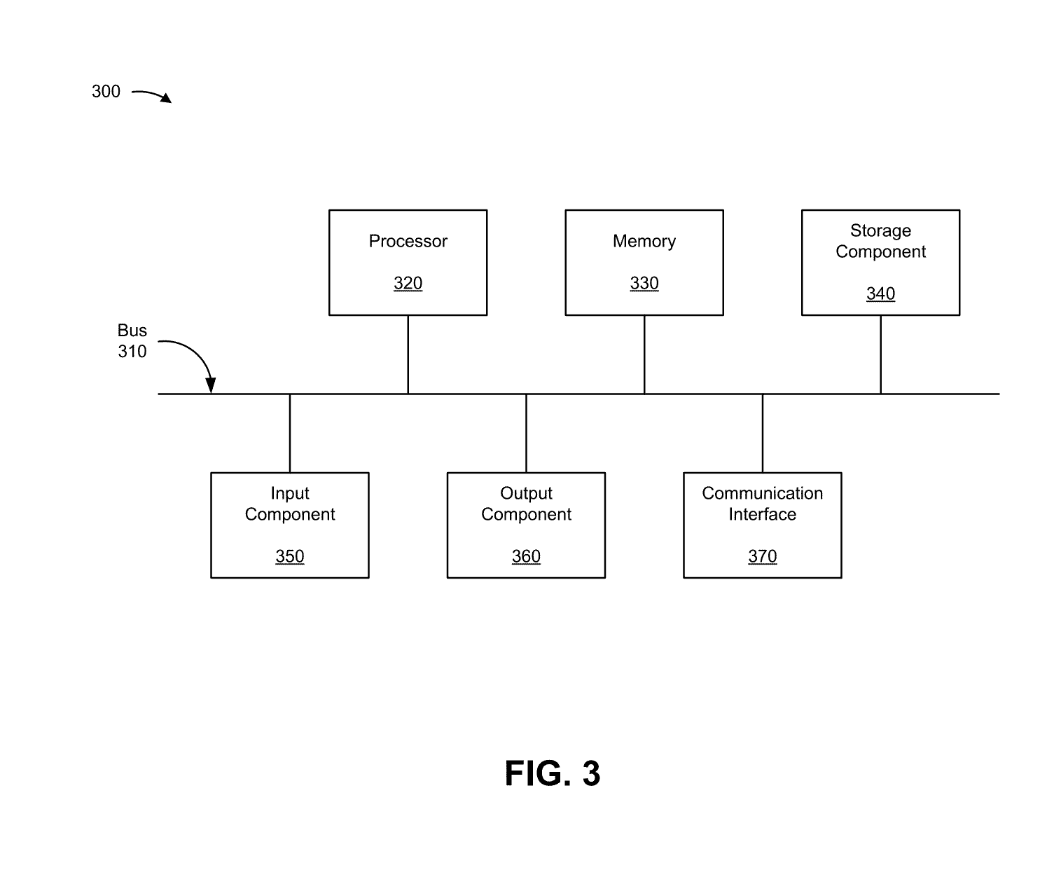

FIG. 3 is a diagram of example components of a device 300. Device 300 may correspond to NPS 210, NA 220, user device 230, and/or ND 250. Additionally, or alternatively, each of NPS 210, NA 220, user device 230, and/or ND 250 may include one or more devices 300 and/or one or more components of device 300.

As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

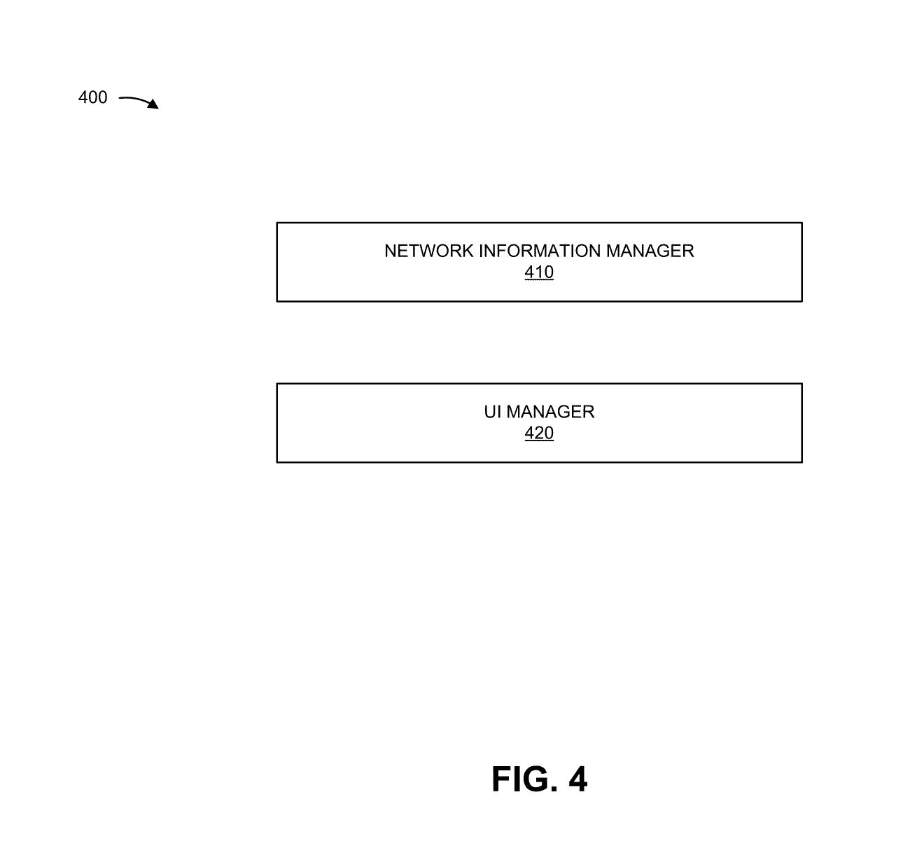

FIG. 4 is a diagram of example functional elements of a device 400 that may correspond to NA 220 and/or user device 230. As illustrated, device 400 may include a network information manager 410 and/or a UI manager 420. Each of functional components 410 and 420 may be implemented using one or more components of device 300. NA 220 and/or user device 230 may individually include all of the functional components illustrated in FIG. 4, or the functional components illustrated in FIG. 4 may be distributed singularly or duplicatively in any manner between NA 220 and user device 230

Network information manager 410 (“NIM 410”) may perform operations associated with managing network information. In some implementations, NIM 410 may receive network information from NPS 210 and/or one or more NDs 250.

Network information received from NPS 210 may include quantities, locations, capacities, parameters, and/or configurations of NDs 250; characteristics and/or configurations (e.g., capacities) of optical links between NDs 250; traffic demands of NDs 250 and/or optical links between NDs 250, and/or any other network information associated with optical network 240 (e.g., optical device configurations, digital device configurations, etc.). In some implementations, a user may model and/or plan optical network 240 using NPS 210. NIM 410 may receive the network information modeled and/or planned using NPS 210, thus providing initial network information to NIM 410.

The initial network information provided to NIM 410 may be supplemented with network information received from one or more NDs 250. For example, NDs 250 may provide real-time network deployment information to update the initial network information provided by NPS 210. For example, NIM 410 may receive network information from NDs 250 that identifies newly-deployed NDs 250 and/or new optical links between NDs 250. Additionally, or alternatively, NIM 410 may receive other network information from NDs 250, such as operational information associated with NDs 250 and/or optical links (e.g., optical link allocation information).

NIM 410 may transmit the network information received from NPS 210 and/or NDs 250 to UI manager 420 to provide a UI that displays network information (e.g., on NA 220 and/or user device 230).

UI manager 420 may perform operations associated with managing a UI that displays network information. UI manager 420 may receive network information from NIM 410, and may provide the network information for display on a device, such as NA 220 and/or user device 230. UI manager 420 may receive a user request for information (e.g., via the UI), and may provide the requested information for display via the UI. Additionally, or alternatively, UI manager 420 may receive information associated with changes to a network configuration from a user interacting with a UI (e.g., via NA 220 and/or user device 230).

As indicated above, FIG. 4 is provided merely as an example of functional components of NA 220 and/or user device 230. Other examples are possible and may differ from what was described with regard to FIG. 4. For example, NA 220 and/or user device 230 may include other functional components that aid in managing network information and/or providing network information for display.

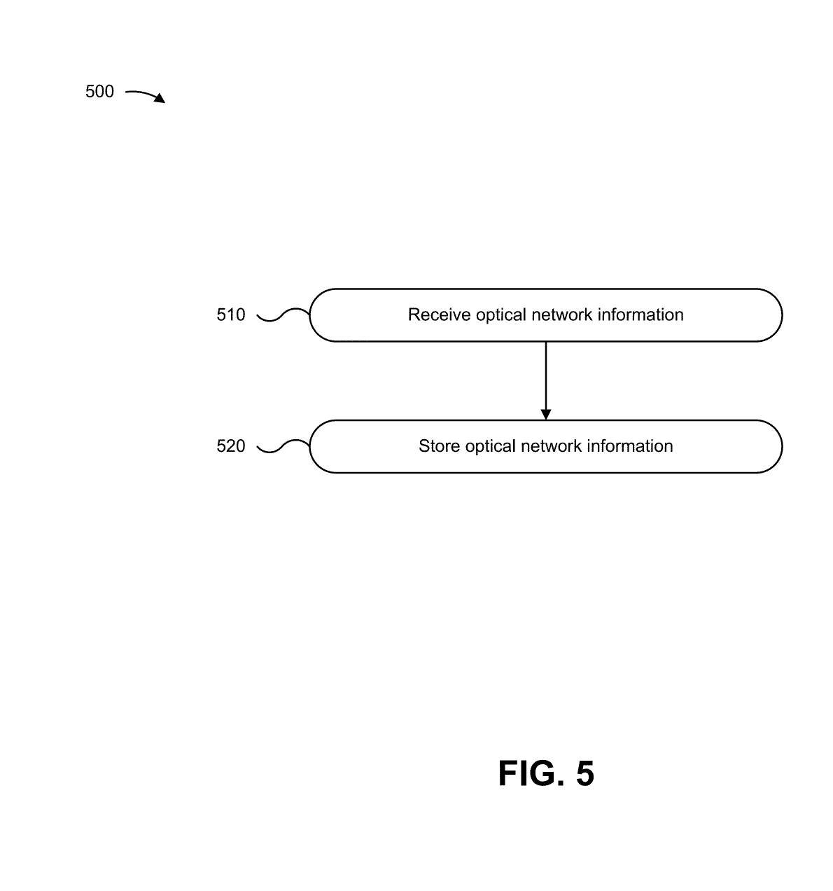

FIG. 5 is a diagram of an example process 500 for receiving and storing network information. In some implementations, one or more process blocks of FIG. 5 may be performed by NA 220 and/or user device 230. In some implementations, one or more process blocks of FIG. 5 may be performed by another device or a group of devices separate from or including NA 220 and/or user device 230, such as NPS 210 and/or ND 250.

As shown in FIG. 5, process 500 may include receiving network information (block 510). For example, NIM 410 may receive the network information from NPS 210 and/or one or more NDs 250.

NIM 410 may request the network information on a periodic basis (e.g., every second, every minute, every hour, every day, every week, etc.). Additionally, or alternatively, NIM 410 may request the network information in response to a user request for the network information. Additionally, or alternatively, NPS 210 and/or NDs 250 may automatically provide the network information to NIM 410 (e.g., on a periodic basis and/or when a configuration is changed).

As further shown in FIG. 5, process 500 may include storing the network information (block 520). For example, NIM 410 may store the network information in a memory associated with NA 220 and/or user device 230.

For example, NIM 410 may store network information associated with NDs 250 and/or optical links between NDs 250, allocation statuses of optical links, alert information associated with NDs 250 and/or optical links, or the like. NIM 410 may associate the stored information with a particular ND 250 and/or a particular optical route. As used herein, a “route” and/or an “optical route” may correspond to an optical path. For example, an optical route may specify a path along which light is carried between two or more NDs 250 and/or between components of a ND 250. An optical route may refer to a series of NDs 250 that connect a source ND 250 to a destination ND 250 for a particular optical transmission.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

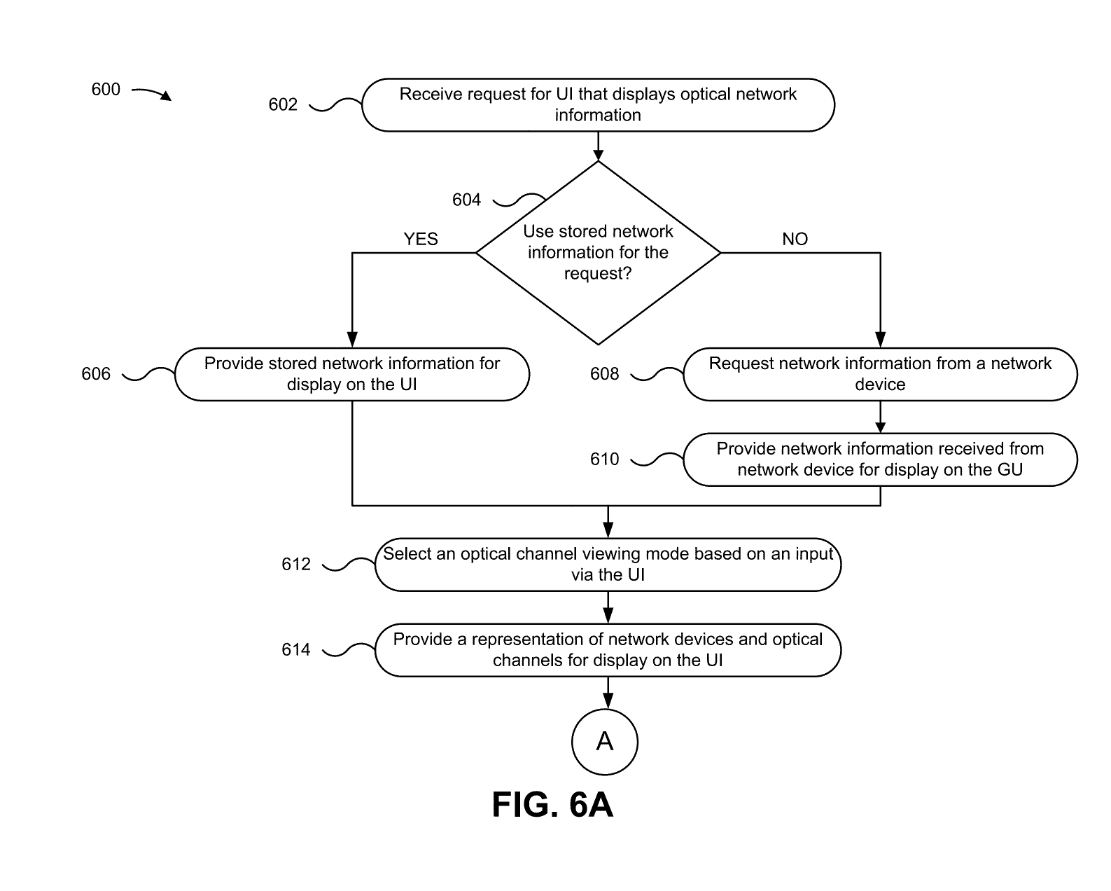

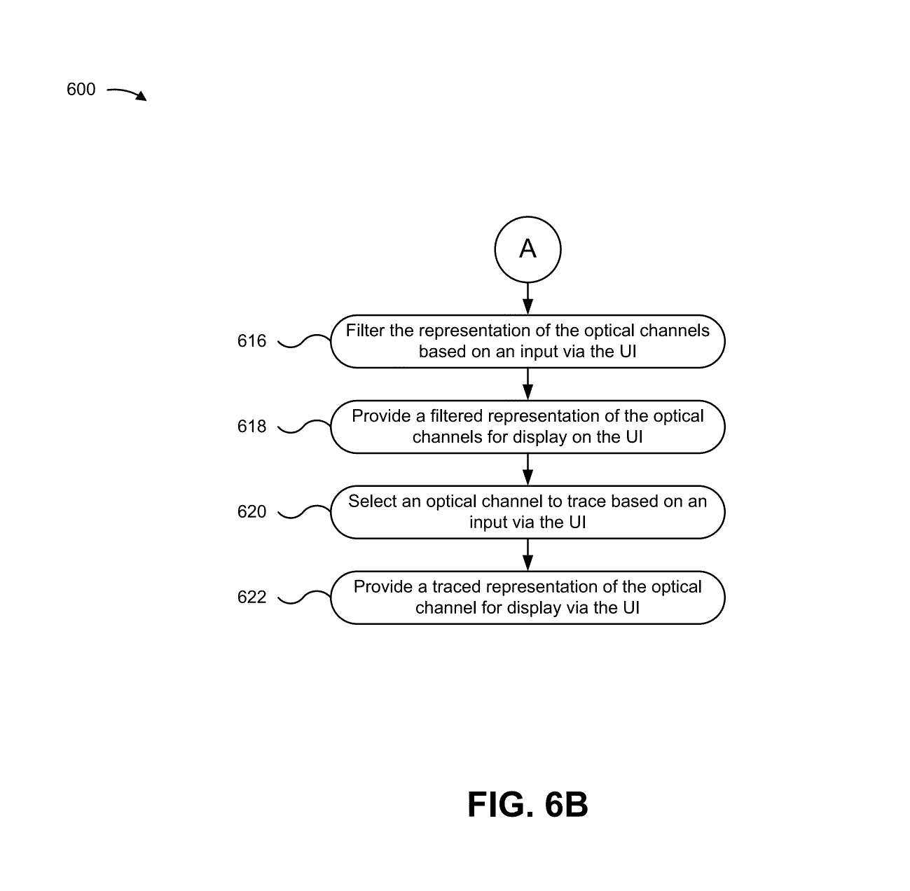

FIGS. 6A and 6B are diagrams of an example process 600 for providing a UI for an optical channel. In some implementations, one or more process blocks of FIGS. 6A and 6B may be performed by NA 220 and/or user device 230. In some implementations, one or more process blocks of FIGS. 6A and 6B may be performed by another device or a group of devices separate from or including NA 220 and/or user device 230, such as NPS 210 and/or ND 250.

As shown in FIG. 6A, process 600 may include receiving a request for a UI that displays network information (block 602). For example, UI manager 420 may receive a request from a user (e.g., interacting with a UI on NA 220 and/or user device 230) for a UI that displays network information.

In some implementations, UI manager 420 may authenticate a user (e.g., using a user name and/or password) and log the user into an account. The account may be associated with an optical network, an optical route, one or more NDs 250 associated with one or more optical routes, optical channels associated with one or more optical routes, and/or any other information associated with optical network 240 and/or one or more optical routes which may be identified by UI manager 420 and/or NIM 410 based on the authentication of the user.

In some implementations, a user may specify one or more optical routes for which to gather network information using a UI (e.g., using a button, a drop-down menu or box, a link, a text box, etc.). The user may specify a particular optical route, NDs 250 associated with a particular optical route, optical channels associated with a particular optical route, and/or any other information associated with an optical route.

As further shown in FIG. 6A, process 600 may include determining whether to use stored network information for the request (block 604). For example, NIM 410 may determine whether to use stored network information based on whether the requested information is stored in a memory (e.g., a memory associated with NA 220 and/or user device 230). Additionally, or alternatively, NIM 410 may determine whether to use stored network information based on a period of time that has passed since the network information and/or the requested information stored in the memory was last updated. Additionally, or alternatively, NIM 410 may receive user input indicating whether to use stored network information or to request network information from NDs 250.

As further shown in FIG. 6A, if the stored network information is determined to be used (block 604—YES), process 600 may include providing the stored network information for display via a UI (block 606). For example, NIM 410 may provide the stored network information to UI manager 420 for display by a device (e.g., NA 220 and/or user device 230). Additionally, or alternatively, NIM 410 may provide UI manager 420 with information that identifies a date and/or time associated with the stored network information (e.g., when the stored network information was last updated).

In some implementations, NA 220 may provide the network information to user device 230 for display via a UI displayed by user device 230.

As further shown in FIG. 6A, if the stored network information is determined not to be used (block 604—NO), process 600 may include requesting the network information from a network device (block 608). For example, NIM 410 may request user-specified network information from NDs 250 associated with one or more user-specified optical routes. NIM 410 may receive the requested network information from NDs 250, and may provide the network information to UI manager 420. In some implementations, NIM 410 may periodically request and/or receive network information from NDs 250 and provide the network information to UI manager 420 for display via a UI. Additionally, or alternatively, NIM 410 may receive network information from NDs 250 when there is a change to the network information so that the UI may display substantially real-time network information.

As further shown in FIG. 6A, process 600 may include providing the network information received from the network device for display via a UI (block 610). For example, NIM 410 may provide the received network information to UI manager 420 for display on a device (e.g., NA 220 and/or user device 230).

Additionally, or alternatively, NIM 410 may provide a combination of stored network information and network information received from NDs 250 to UI manager 420 for display on a device (e.g., NA 220 and/or user device 230). When information and/or a configuration associated with NDs 250 changes, the UI may be updated to display substantially real-time information associated with NDs 250.

In some implementations, NA 220 may provide the network information to user device 230 for display via a UI displayed by user device 230.

As further shown in FIG. 6A, process 600 may include selecting an optical channel viewing mode based on an input via the UI (block 612). For example, UI manager 420 (e.g., included in NA 220 and/or user device 230) may select the optical channel viewing mode.

UI manager 420 may cause a device (e.g., NA 220 and/or user device 230) to display the UI. A user may input a selection, via the UI presented by UI manager 420, to enter the optical channel viewing mode. For example, the user may input the selection using a button, a drop-down menu or box, a link, a text box, or the like included in the UI. UI manager 420 may select the optical channel viewing mode based on the inputted selection.

The optical channel viewing mode may be a mode in which a representation of devices included in an optical channel layer (e.g., NDs having ports used to provision an optical channel) are displayed. In some implementations, a representation of devices included only in the optical channel layer may be displayed in the optical channel viewing mode and a representation of devices in an optical transmission section layer may be hidden or prevented from being displayed. For example, a representation of devices in an optical transmission section layer may be displayed in another mode and hidden when the optical channel viewing mode is selected. Furthermore, a representation of physical links and/or logical links between devices and/or within devices may displayed in the optical channel viewing mode.

As further shown in FIG. 6A, process 600 may include providing a representation of NDs 250 and optical channels for display via the UI (block 614). For example, UI manager 420 (e.g., included in NA 220 and/or user device 230) may provide a representation of NDs 250 and optical channels for display in the optical channel viewing mode.

The representation of NDs 250 may include ND display elements, ND component display elements for NDs 250, a spectral slice display element, and/or optical cross connect elements in an optical route for the identified optical channel(s).

An ND display element may display a representation of ND 250. The ND display element may include one or more ND component display elements. An ND component display element may display a representation of a component of ND 250, a capability associated with ND 250, and/or a parameter associated with ND 250.

In some implementations, the ND component display element may include a physical TP display element that represents a physical component (e.g., a physical port) through which an optical channel is provisioned. A physical TP display element may be associated with multiple optical channels. In other words, multiple optical channels (e.g., super-channels) may pass through the same physical component represented by the physical TP display element.

Additionally, or alternatively, the ND component display element may include a logical TP display element that represents a logical component through which an optical channel is provisioned. A logical TP display element may be associated with a single optical channel. In other words, only a single optical channel (e.g., super-channel) may pass through the same logical component represented by the logical TP display element. The physical TP display element and the logical TP display element may be displayed differently within the UI to distinguish between a physical TP display element and a logical TP display element. For example, the physical TP display element may have a different size, shape, color, font, border, or the like than the logical TP display element.

The ND display element, the ND component display element, the physical TP display element, and/or the logical TP display element may include network information. For example, the ND display element, the ND component display element, the physical TP display element, and/or the logical TP display element may include an identifier that identifies a respective ND 250 and/or component of ND 250 (e.g., a port identifier that identifies a physical port, a logical node identifier that identifies a logical node, a ND identifier that identifies a respective ND 250, a component identifier that identifies a component of ND 250, etc.), an optical channel identifier that identifies an optical channel provisioned by a component represented by a respective display element, an alarm identifier that identifies an alarm for a component represented by the respective display element, a power value indicating a transmission power and/or a reception power at a component represented by the respective display element, and/or a service state of a component represented by a respective display element.

A spectral slice display element may indicate a set of spectral slices (e.g., a set of optical channels and/or super-channels). For example, the spectral slice display element may display a list of super-channels transmitted via a physical connection between NDs 250. The spectral slice display element may include a spectral slice identifier that identifies a spectral slice (e.g., an optical channel and/or super-channel).

An optical cross connect display element may indicate a transmission path of an optical channel through a ND 250, a physical component (e.g., a physical port), and/or a logical component. The optical cross connect display element may be displayed as a connector (e.g., a line) that connects a ND display element, a ND component display element, a physical TP display element, and/or a logical TP display element.

An optical cross connect display element may include a physical connect display element that represents a physical connection between components (e.g., an optical fiber between two physical ports). A physical connect display element may be associated with multiple optical channels. In other words, multiple optical channels (e.g., super-channels) may pass through the same physical connection represented by the physical connect display element.

Additionally, or alternatively, an optical cross connect display element may include a logical connect display element that represents a logical connection and/or switching between components. A logical connect display element may be associated with a single optical channel. In other words, a single optical channel (e.g., super-channel) may pass through the same logical connection represented by the logical connect display element. The physical connect display element and the logical connect display element may be displayed differently within the UI to distinguish between a physical connect display element and a logical connect display element. For example, the physical connect display element may have a different size, shape, color, font, border, or the like than the logical connect display element.

In this way, a visual conception of an optical channel, including a transmission path of the optical channel through various NDs 250 and/or components of NDs 250, may be presented to a user via the UI.

In some implementations, optical cross connect display elements may be displayed for multiple optical channels. In such a case, the optical cross connect display elements may be difficult to view individually due to different optical cross connect display elements overlapping one another and due to the space between ND component display elements, physical TP display elements, and/or logical TP display elements. Accordingly, in some implementations, if optical cross connect display elements are to be displayed for a quantity of optical channels that satisfy a threshold quantity of optical channels, a summarized optical cross connect display element may be displayed between two components that represents the optical cross connect display elements, rather than showing each optical cross connect display element individually. For example, a common set of connectors (e.g., horizontal and/or vertical lines) may be displayed as the summarized optical cross connect display element that combine the logical connect display elements between ND component display elements, physical TP display elements, and/or logical TP display elements. Additionally, or alternatively, the optical cross connect display elements may highlighted differently based on the quantity of optical channels satisfying the threshold quantity of optical channels.

As shown in FIG. 6B, process 600 may include filtering the representation of the optical channels based on an input via the UI (block 616). For example, UI manager 420 (e.g., included in NA 220 and/or user device 230) may filter the representation of the optical channels.

A user may input a selection, via the UI presented by UI manager 420, to filter the optical channels displayed by the UI. For example, the user may input the selection using a button, a drop-down menu or box, a link, a text box, or the like included in the UI.

The user may select a quantity of optical channels to be displayed at a same time and/or particular optical channel(s) to be displayed at a same time. UI manager 420 may filter the optical channels currently displayed by the UI or provided for display by the UI based on the user selection.

UI manager 420 may generate a filtered representation based on filtering the optical channels based on the user input. For example, UI manager 420 may prevent optical cross connect display elements for non-selected optical channels from being provided for display.

Alternatively, UI manager 420 may filter the optical channels currently displayed by changing how optical cross connect display elements are displayed. For example, the optical cross connect display elements for the non-selected optical channels, in the filtered representation, may be deemphasized (e.g., changed to lighter color, faded out, etc.) and/or the optical cross connect display elements for the selected optical channels may be emphasized (e.g., changed to a darker color, highlighted, etc.).

In some implementations, a ND component display element, a physical display element, and/or a logical display element that is not associated with a selected optical channel may be displayed differently than a ND component display element, a physical display element, and/or a logical display element that is associated with a selected optical channel. For example, in the filtered representation, the ND component display element, the physical display element, and/or a logical display element that is not associated with a selected optical channel may have previously displayed network information removed, and only a ND component display element, a physical display element, and/or a logical display element that is associated with a selected optical channel may have network information displayed. Additionally, or alternatively, a color, shape, size, etc. of a ND component display element, a physical display element, and/or a logical display element that is not associated with a selected optical channel may be changed based on the filtering.

In some implementations, display of the spectral slice display element may be changed in the filtered representation. For example, the spectral slice display element may include spectral slice identifiers for only the selected optical channels, and may not include spectral slice identifiers for non-selected optical channels.

As further shown in FIG. 6B, process 600 may include providing a filtered representation of the optical channels for display via the UI (block 618). For example, UI manager 420 (e.g., included in NA 220 and/or user device 230) may provide the filtered representation for display.

In this way, a user may filter a visual conception of the optical channel presented to the user via the UI so that the user may more easily visualize particular optical channels.

As further shown in FIG. 6B, process 600 may include selecting an optical channel to trace based on an input via the UI (block 620). For example, UI manager 420 (e.g., included in NA 220 and/or user device 230) may select an optical channel to trace.

A user may input a selection, via the UI presented by UI manager 420, to trace an optical channel displayed by the UI. For example, the user may input the selection using a button, a drop-down menu or box, a link, a text box, or the like included in the UI. In some implementations, the user may select an optical channel to trace by selecting a logical display element associated with an optical channel.

UI manager 420 may generate a traced representation based on selecting an optical element to trace. The traced representation may emphasize ND component display elements, physical TP elements, logical TP elements, optical cross connect elements, and/or a spectral slice identifier, included in the spectral slice display element, that is associated with the selected optical channel. For example, the ND component display elements, the physical TP elements, the logical TP elements, the optical cross connect elements, and/or a spectral slice identifier, included in the spectral slice display element may be highlighted and/or have size, shapes, colors, or the like changed. The traced representation may indicate a source of the optical channel, a destination of the optical channel, and/or a transmission path of the optical channel via physical ports.

In some implementations, a user may select more than one optical channel to trace and more than one optical channel may be traced in the traced representation. In such a case, the transmission path for the optical channels may be traced differently to visually distinguish the optical channels so a user may easily distinguish one transmission path from another.

As further shown in FIG. 6B, process 600 may include providing a traced representation of the optical channel for display via the UI (block 622). For example, UI manager 420 (e.g., included in NA 220 and/or user device 230) may provide the traced representation of the optical channel for display.

In this way, a user may trace an optical channel presented to the user via the UI so that the user may more easily visualize the optical channel.

Although FIGS. 6A and 6B show example blocks of process 600, in some implementations, process 600 may include additional blocks, fewer blocks, different blocks, or differently arranged blocks than those depicted in FIGS. 6A and 6B. Additionally, or alternatively, two or more of the blocks of process 600 may be performed in parallel.

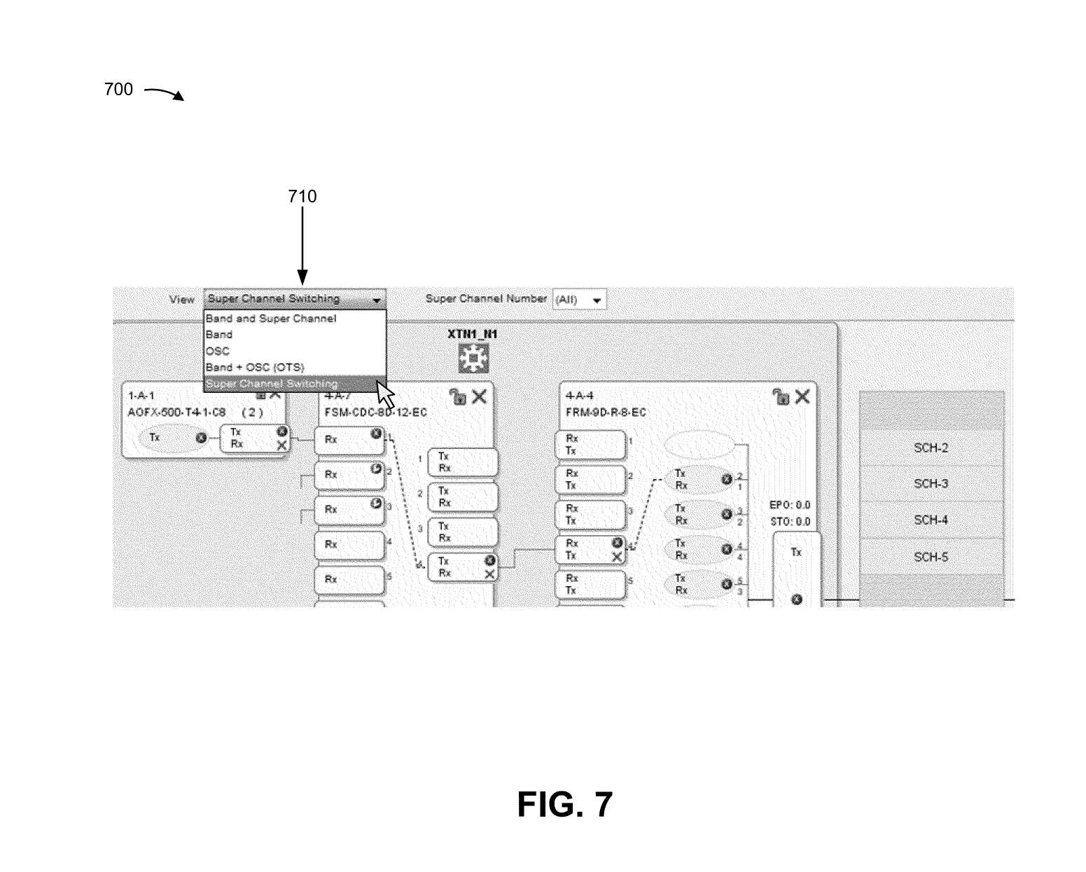

FIG. 7 is a diagram of an example implementation 700 relating to example process 600 shown in FIGS. 6A and 6B. FIG. 7 shows an example of providing a UI for an optical channel. Specifically, FIG. 7 illustrates a UI for selecting a super channel switching viewing mode (e.g., an optical channel viewing mode).

As shown in FIG. 7, NA 220 and/or user device 230 may provide a UI for display. The UI may include a view selector 710. View selector 710 may be a pull down box that allows a user to select a view for the UI from among multiple available view modes.

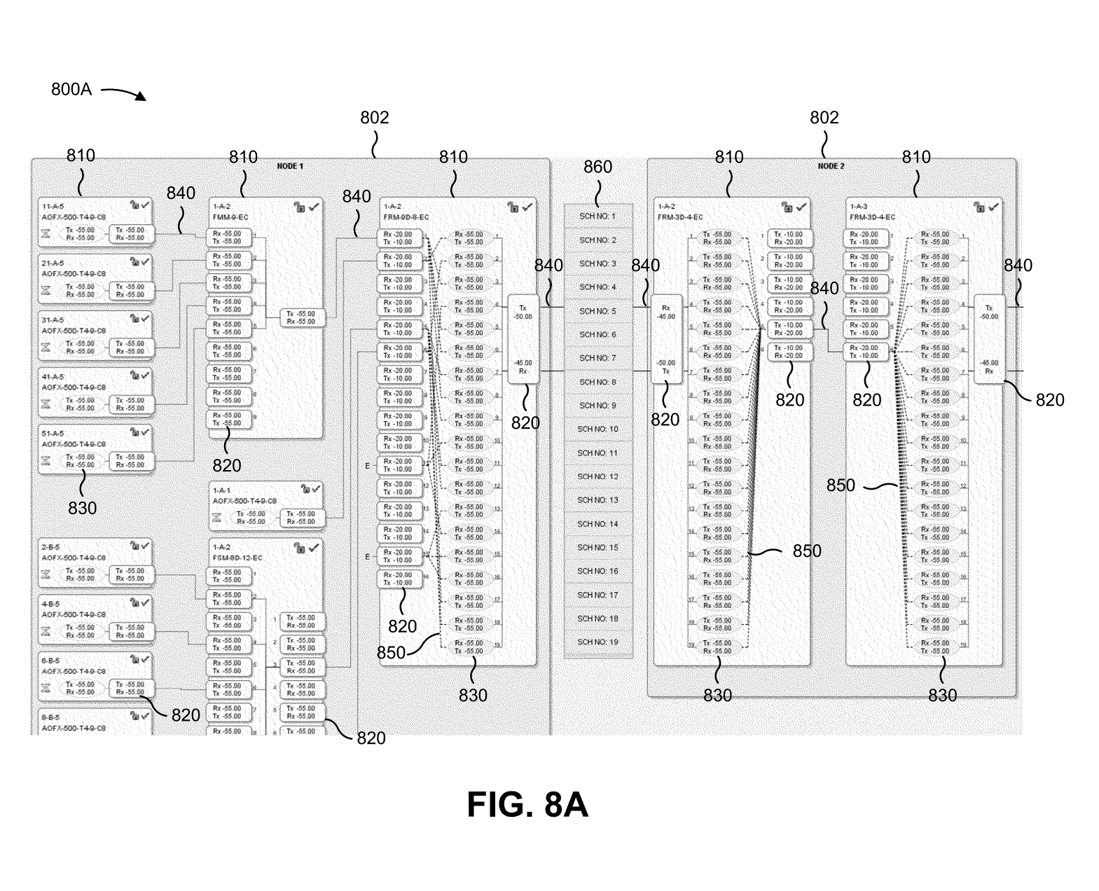

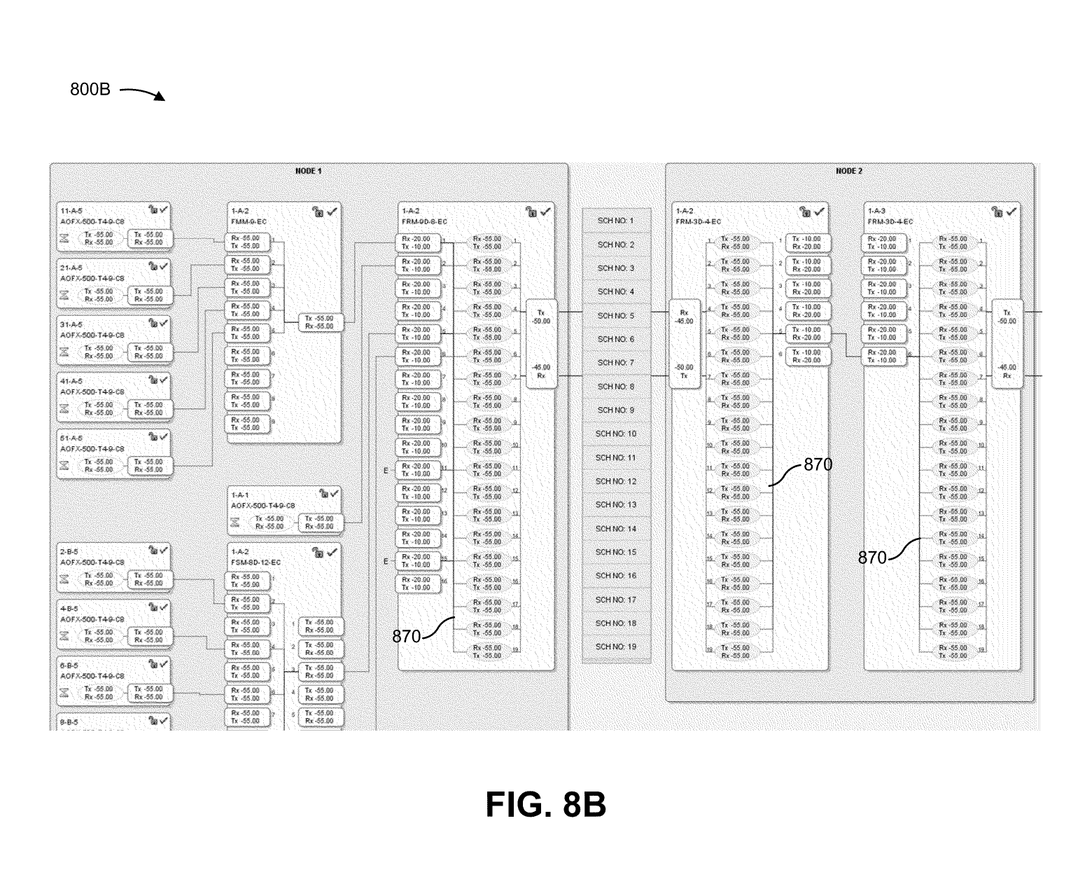

As further shown in FIG. 7, the user may use a cursor to select “Super Channel Switching” to select the super channel switching viewing mode from among the available view modes. Accordingly, the super channel switching viewing mode may be activated to allow a user to trace and/or filter super-channels. For example, the UIs shown in FIGS. 8A and 8B may be displayed based on the super channel switching viewing mode being activated.

As indicated above, FIG. 7 is provided merely as an example. Other examples are possible and may differ from what was described with regard to FIG. 7.

FIGS. 8A and 8B are diagrams of example implementation 800A and 800B relating to example process 600 shown in FIGS. 6A and 6B. FIGS. 8A and 8B show an example of providing a UI for an optical channel. Specifically, FIGS. 8A and 8B illustrate an example UI displayed based on an optical channel viewing mode being selected.

In FIG. 8A, assume a user has selected an optical channel viewing mode. The displayed UI may include ND display elements 802, ND component display elements 810, physical TP display elements 820, logical TP display elements 830, physical connect display elements 840, logical connect display elements 850, and a spectral slice display element 860.

As shown in FIG. 8A, a ND display element 802 may represent ND 250 and a ND component display element 810 may represent a component within ND 250. A ND component display element 810 may include a physical TP display element 820 and/or a logical TP display element 830. The physical TP display element 820 may represent a port within ND, 250 and logical TP display element 830 may represent a logical connection path for a super-channel provisioned by ND 250. As shown in FIG. 8A, physical TP display element 820 may be displayed as a rectangle and logical TP display element 830 may be displayed as oval to distinguish between the two different kinds of TP display elements. Additionally, each physical TP display element 820 and each logical TP display element 830 may include network information, such as transmission power (Tx) and reception power (Rx).

As further shown in FIG. 8A, a physical connect display element 840 may connect physical TP display elements 820 indicating a physical connection between the physical TP display elements 820. A logical connect display element 850 may connect a physical TP display element 820 to a logical TP display element 830 indicating a logical connection between the physical TP display element 820 and the logical TP display element 830. The logical TP display element 830 may indicate a logical connection for a particular super-channel. As shown in FIG. 8A, physical connect display elements 840 may be displayed as solid lines and logical connect display elements 850 may be displayed as dashed lines to distinguish between the different kinds of cross connect display elements. Thus, a user may be easily distinguish between the different kinds of cross connect display elements.

As further shown in FIG. 8A, spectral slice display element 860 may be displayed between ND display elements 802 and indicate super-channels transmitted between NDs 250. For example, as shown, the spectral slice display element 860 includes 19 super-channel identifiers (SCH NO. 1-SCH NO. 19) that identify 19 super-channels transmitted between NDs 250.

As can be seen in FIG. 8A, when 19 super-channels are displayed via the UI, the logical connect display elements 850 for the 19 super-channels may be difficult to comprehend individually.

Accordingly, as shown in FIG. 8B, in some implementations, the individual logical connect display elements 850 may be replaced with a summarized optical cross connect display element 870. For example, the summarized optical cross connect display element 870 may be displayed if logical connect display elements 850 for more than a threshold quantity of super-channels (e.g., four, five, ten etc.) are to be displayed.

As indicated above, FIGS. 8A and 8B are provided merely as an example. Other examples are possible and may differ from what was described with regard to FIGS. 8A and 8B.

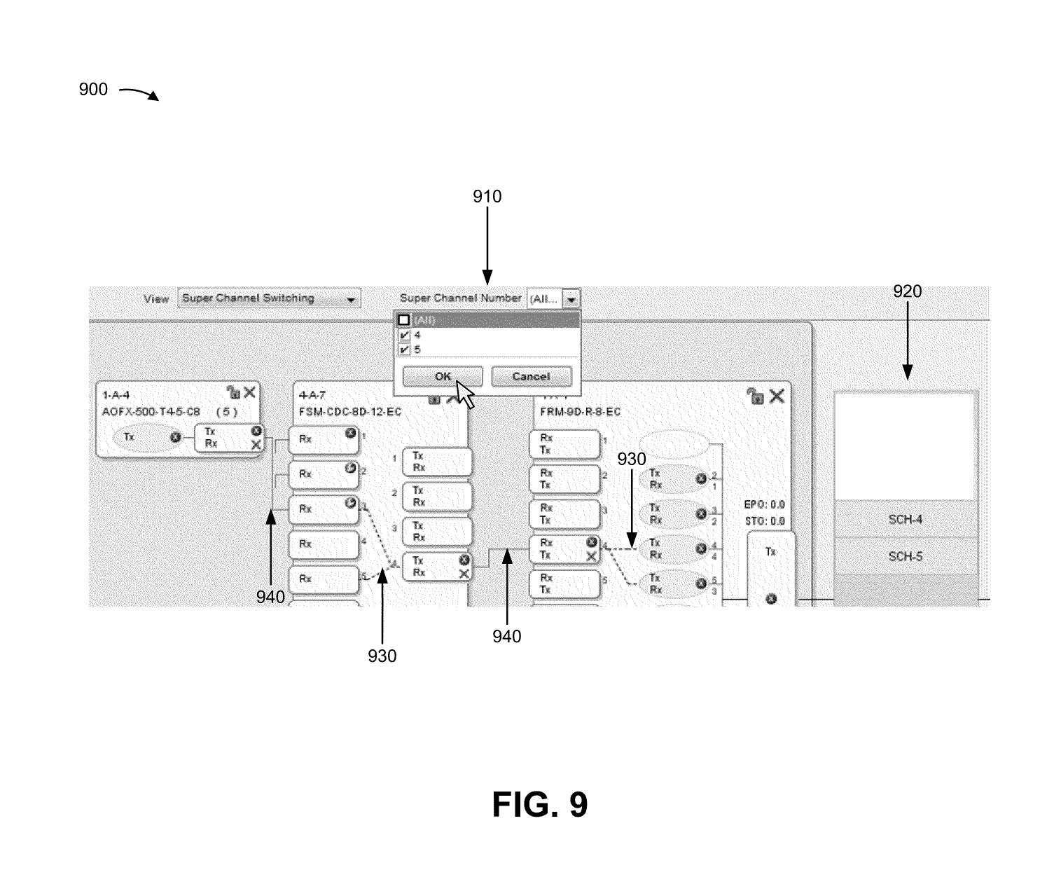

FIG. 9 is a diagram of an example implementation 900 relating to example process 600 shown in FIGS. 6A and 6B. FIG. 9 shows an example of providing a UI for an optical channel. Specifically, FIG. 9 illustrates filtering super-channels displayed in a UI in an optical channel viewing mode.

As shown in FIG. 9, NA 220 and/or user device 230 may provide a UI for display. The UI may include a super-channel number selector 910. Super-channel number selector 910 may be a pull down box that allows a user to select particular super-channels to be displayed in the UI.

As further shown in FIG. 9, assume that the user uses a cursor to select super-channels 4 and 5 to be displayed from among possible super-channels (e.g., super-channels 1-19). UI manager 420 may filter the displayed super-channels based on the selection so that super-channel identifiers for only super-channels 4 and 5 (e.g., SCH-4 and SCH-5) are displayed in spectral slice display element 920. Likewise, logical connect display elements 930 for only super-channels 4 and 5 may be displayed and logical connect display elements for non-selected super-channels may be hidden. Similarly, physical connect display elements 940 for only super-channels 4 and 5 may be displayed and physical connect display elements for non-selected super-channels may be hidden.

As indicated above, FIG. 9 is provided merely as an example. Other examples are possible and may differ from what was described with regard to FIG. 9.

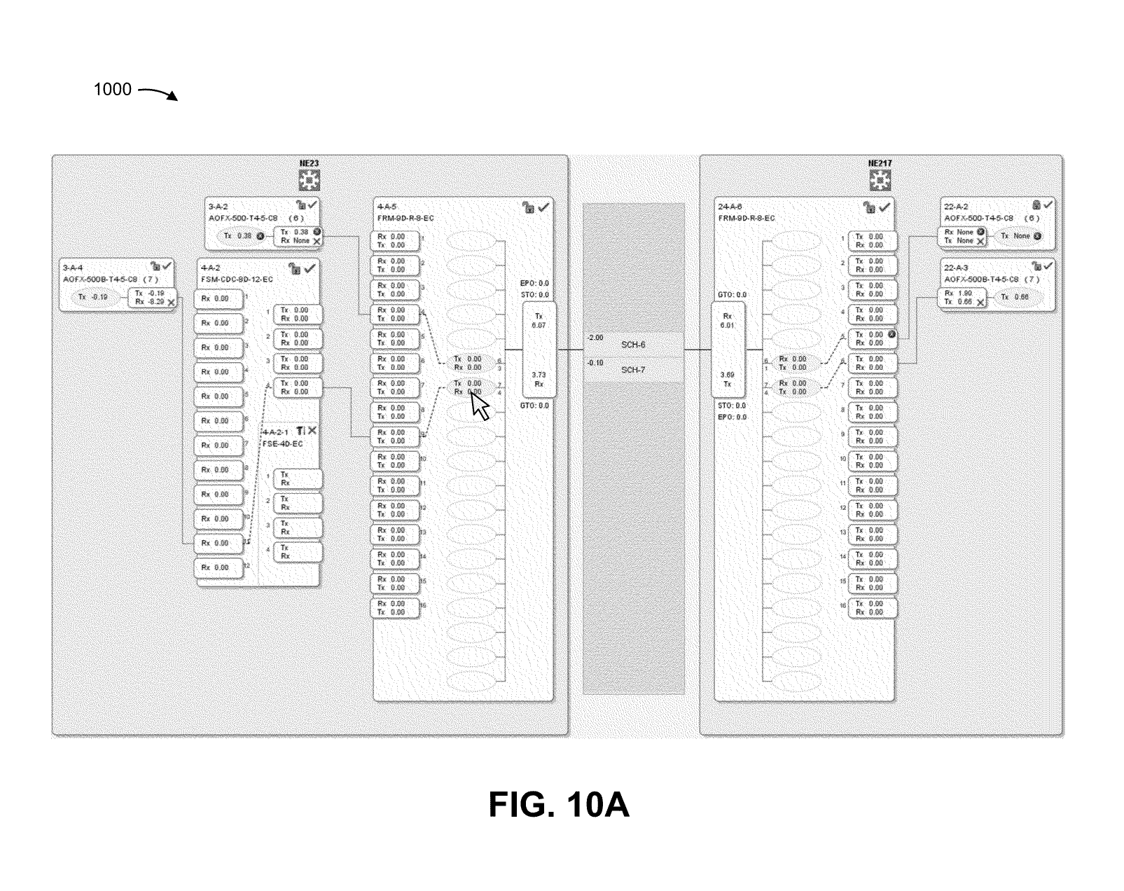

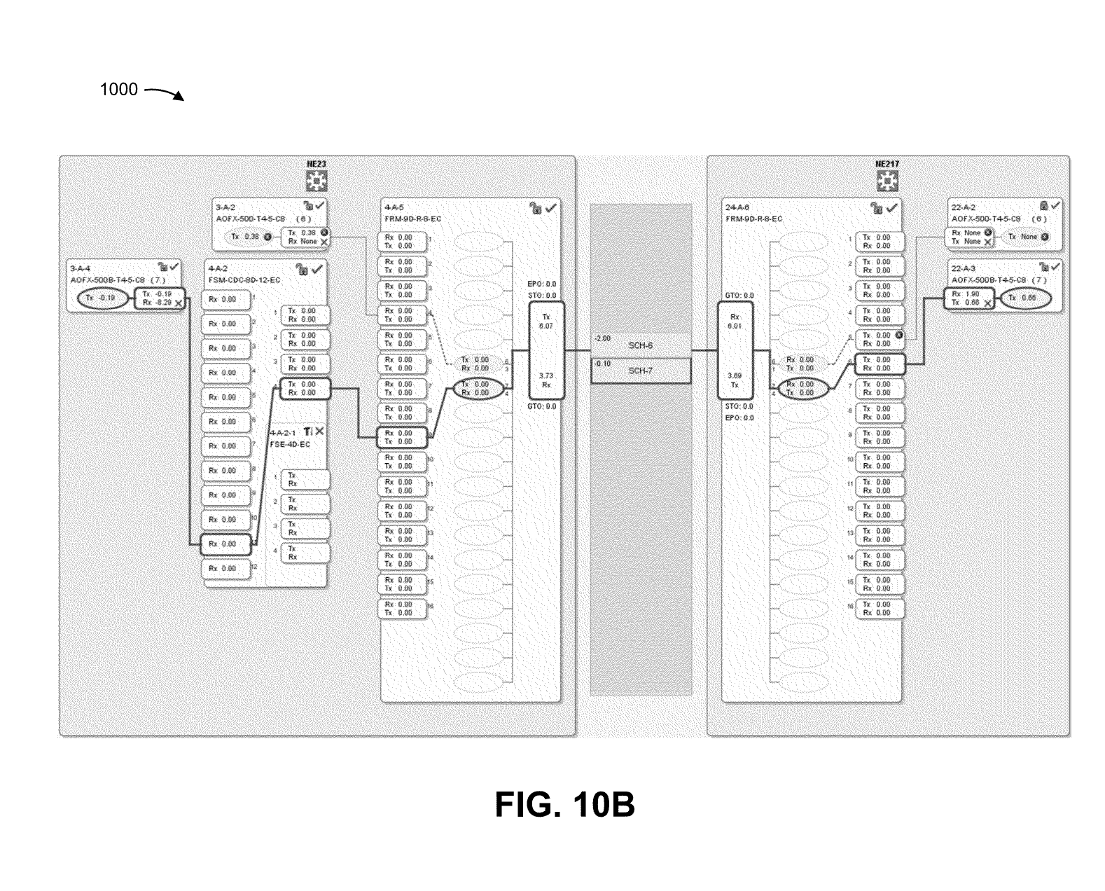

FIGS. 10A and 10B are diagrams of an example implementation 1000 relating to example process 600 shown in FIGS. 6A and 6B. FIGS. 10A and 10B show an example of providing a UI for an optical channel. Specifically, FIGS. 10A and 10B illustrate an example of tracing a super-channel (e.g., an optical channel) in a UI in an optical channel viewing mode.

In FIG. 10A, assume a user has filtered the super-channels and selected super-channels 6 and 7 for display in the UI. Accordingly, super-channel identifiers (e.g., SCH-6 and SCH-7) for only super-channels 6 and 7 are displayed in a spectral slice display element.

Further, assume a user uses a cursor to select one of the logical TP display elements so as to select a super-channel to be traced. Assume the logical TP display element selected is for super-channel 7.

As shown in FIG. 10B, UI manager 420 may trace super-channel 7 by highlighting each physical TP display element, each logical TP display element, each physical connect display element, and each logical connect display element through which the super-channel 7 travels. In this way, a user may easily comprehend the transmission path of the super-channel.

As indicated above, FIGS. 10A and 10B are provided merely as an example. Other examples are possible and may differ from what was described with regard to FIGS. 10A and 10B.

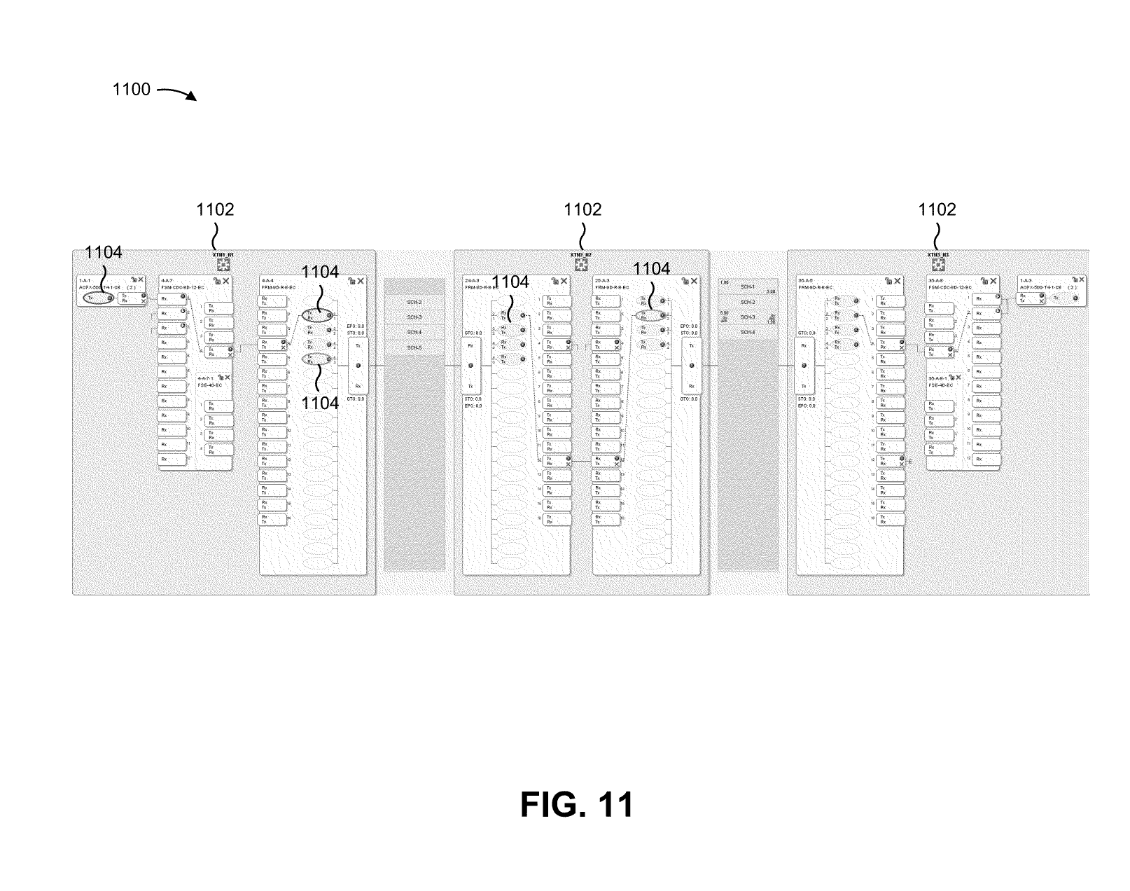

FIG. 11 is a diagram of an example implementation 1100 relating to example process 600 shown in FIGS. 6A and 6B. FIG. 11 shows an example of providing a UI for an optical channel. Specifically, FIG. 11 illustrates alarms displayed by the UI. Furthermore, FIG. 11 illustrates a view of three ND display elements 1102 displayed by the UI. The UI may include any number of ND display elements 1102 that represent NDs between and including a source ND a destination ND.

As shown in FIG. 11, the UI may indicate an alarm 1104 at a logical TP display element. For example, the TP display element may be outlined in a particular color to indicate an alarm condition for the logical TP display element. Different colors may represent different alarms.

As indicated above, FIG. 11 is provided merely as an example. Other examples are possible and may differ from what was described with regard to FIG. 9.

Implementations described herein may assist a user in obtaining and viewing aggregated network information, such as network information associated with network devices and optical channels transferred between the network devices and between components of a network device. For example, implementations described herein may allow a user to obtain a trace of optical channels in a link viewer, filter the optical channels displayed in the link viewer, and/or switch between different optical channels displayed in the link viewer.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a user interface, a non-user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive network information for an optical network,
the network information originating from at least one network device included in the optical network,
provide a user interface for display based on the network information,
the user interface including first display elements representing physical components in the optical network,
the user interface including second display elements representing logical components in the optical network,
the user interface including third display elements representing physical connections in the optical network,
the user interface including fourth display elements representing logical connections in the optical network,
the user interface providing information regarding a plurality of optical channels transmitted via one or more of the physical components, one or more of the logical components, one or more of the physical connections, and one or more of the logical connections;
receive a selection of an optical channel of the plurality of optical channels via the user interface; and
visually distinguish, within the user interface and based on the selection, a transmission path associated with the optical channel,
the transmission path including at least one of the physical components, at least one of the logical components, at least one of the physical connections, and at least one of the logical connections.

2. The device of claim 1, where the optical channel is a super-channel.

3. The device of claim 1, whereat least one of the fourth display elements connects a first display element and a second display element representing a logical connection between a physical component and a logical component,
the first display elements including the first display element,
the second display elements including the second display element,
the logical connections including the logical connection,
the physical components including the physical component, and
the logical components including the logical component.

4. The device of claim 1, where the user interface further indicates a fifth display element representing the at least one network device included in the optical network,
the at least one network device including the at least one of the physical components, the at least one of the logical components, the at least one of the physical connections, and the at least one of the logical connections included in the transmission path.

5. The device of claim 1, where the one or more processors, when visually distinguishing the transmission path, are further to:
provide a tracing of the transmission path through at least one of the first display elements that represents the at least one of the physical components included in the transmission path, through at least one of the second display elements that represents the at least one of the logical components included in the transmission path, through at least one of the third display elements that represents the at least one of the physical connections included in the transmission path, and through at least one of the fourth display elements that represents the at least one of the logical connections included in the transmission path.

6. The device of claim 5, where the one or more processors, when providing the tracing of the transmission path, are further to:
cause a display of the at least one of the first display elements, the at least one of the second display elements, the at least one of the third display elements, and the at least one of the fourth display elements to be visually emphasized relative to at least one other one of the first display elements, at least one other one of the second display elements, at least one other one of the third display elements, and at least one other one of the fourth display elements.

7. The device of claim 1, where the one or more processors, when receiving the selection, are further to:
receive the selection of the optical channel via a user selection of a second display element via the user interface,
the second display element representing a logical component included in the transmission path associated with the optical channel,
the second display elements including the second display element, and
the at least one of the logical components included in the transmission path including the logical component.

8. A computer-readable medium storing instructions, the instructions comprising:
one or more instructions that, when executed by one or more processors, cause the one or more processors to:
receive network information for an optical network,
the network information originating from at least one network device included in the optical network,
provide a user interface for display based on the network information,
the user interface including first display elements representing physical components in the optical network,
the user interface including second display elements representing logical components in the optical network,
the user interface including third display elements representing physical connections in the optical network,
the user interface including fourth display elements representing logical connections in the optical network,
the user interface including fifth display elements indicating optical channels transmitted via one or more of the physical components, one or more of the logical components, one or more of the physical connections, and one or more of the logical connections;
receive a selection of a subset of the optical channels via the user interface;
filter the user interface based on the selection to form a filtered user interface,
the filtered user interface including a subset of the fifth display elements that are associated with the subset of the optical channels; and
provide the filtered user interface for display.

9. The computer-readable medium of claim 8, where a quantity of the optical channels represented by the fifth display elements satisfy a threshold level, and
where the fourth display elements represent a combined representation of the logical connections in the optical network based on the quantity of the optical channels satisfying the threshold level.

10. The computer-readable medium of claim 8, where a quantity of the optical channels represented by the fifth display elements fail to satisfy a threshold level, and
where the fourth display elements represent the logical connections individually based on the quantity of the optical channels failing to satisfy the threshold level.

11. The computer-readable medium of claim 8, where the fifth display elements include optical channel identifiers that identify the optical channels.

12. The computer-readable medium of claim 8, where the subset of fifth display elements is a first subset of the fifth display elements,
the filtered user interface including the first subset of the fifth display elements that are associated with the subset of the optical channels,
the filtered user interface hiding, from view, a second subset of the fifth display elements that are not associated with the subset of the optical channels,
the fifth display elements, included in the user interface, including the first subset of the fifth display elements and the second subset of the fifth display elements.

13. The computer-readable medium of claim 8, where the filtered user interface includes power information for at least one of the physical components and at least one of the logical components through which an optical channel, included in the subset of the optical channels, passes.

14. The computer-readable medium of claim 8, where the filtered user interface includes a first subset of the fourth display elements that represent logical connections through which the subset of the optical channels pass,
the filtered user interface hiding, from view, a second subset of the fourth display elements that represent logical connections through which the subset of the optical channels do not pass,
the fourth display elements, included in the user interface, including the first subset of the fourth display elements and the second subset of the fourth display elements.

15. A method, comprising:
receiving, by a device, network information for an optical network,
the network information originating from at least one network device included in the optical network,
providing, by the device, a user interface for display based on the network information,
the user interface including first display elements representing physical components in the optical network,
the user interface including second display elements representing logical components in the optical network,
the user interface including third display elements representing physical connections in the optical network,
the user interface including fourth display elements representing logical connections in the optical network,
the user interface including fifth display elements representing a plurality of super-channels transmitted via one or more of the physical components, one or more of the logical components, one or more of the physical connections, and/or one or more of the logical connections;
receiving, by the device, a selection of a super-channel of the plurality of super-channels via the user interface; and
causing, by the device, the user interface to visually distinguish, based on the selection, a transmission path associated with the super-channel,
the transmission path including at least one of the physical components, at least one of the logical components, at least one of the physical connections, and/or at least one of the logical connections.

16. The method of claim 15, where causing the user interface to visually distinguish the transmission path further comprises:
tracing the super-channel from a source of the super-channel to a destination of the super-channel.

17. The method of claim 15, where causing the user interface to visually distinguish the transmission path further comprises:
causing the user interface to visually emphasize at least one of the first display elements, at least one of the second display elements, at least one of the third display elements, at least one of the fourth display elements, and at least one of the fifth display elements relative to at least one other one of the first display elements, at least one other one of the second display elements, at least one other one of the third display elements, at least one other one of the fourth display elements, and at least one other one of the fifth display elements.

18. The method of claim 15, where the user interface presents the third display elements using a different representation than the fourth display elements.

19. The method of claim 15, where the user interface presents the first display elements using a different representation than the second display elements.

20. The method of claim 15, where the user interface includes a representation of the physical components and the logical components included in a super-channel layer and hides, form view, a representation of physical components and logical components included only in an optical transmission section layer.
